(19) United States
(12) Patent Application Publication
(10) Pub. No.: US 2025/0092531 A1
(43) Pub. Date: Mar. 20, 2025

(54) PROCESSES FOR THE CONTINUOUS PRODUCTION OF HYDROGEN GAS

(71) Applicant: Uri Givan, Tel Aviv (IL)

(72) Inventors: Uri GIVAN, Tel Aviv (IL); Maurice ARTOUL, Tel Aviv (IL); Netta MENTOVICH, Tel Aviv (IL)

(21) Appl. No.: 18/729,528

(22) PCT Filed: Jan. 19, 2023
(86) PCT No.: PCT/IL2023/050061

§ 371 Date: Jul. 17, 2024

Related U.S. Application Data
(60) Provisional application No. 63/300,796, filed on Jan. 19, 2022.

(51) Int. Cl. C25B 1/02; C25B 11/042

(52) U.S. Cl. CPC C25B 1/02; C25B 11/042

(57) ABSTRACT

The invention generally concerns processes for the production of hydrogen gas.

### TECHNOLOGICAL FIELD

The invention generally concerns processes for the continuous production of hydrogen gas.

### BACKGROUND

There is an urgent need for clean and renewable fuel alternatives for the global energy supply as well as its wide industrial use.

Hydrogen gas is a high calorific value environmentally friendly fuel due to being carbon-free and a high conversion efficiency to electricity. Numerous methods have been developed to produce hydrogen gas. The reforming of hydrocarbons is the most dominating process, mainly benefitting from its low-price and scientifically mature technology. However, as this process relies on fossil fuel consumption, processes for producing hydrogen that are fossil-fuel-free are preferred and presently sought for.

Metals are high energy density unconventional hydrogen gas production materials, proposed as alternatives to fossil fuel-based hydrogen production technologies. Indirect storage of hydrogen gas in reactive metals, such as iron, has been explored utilizing reactions between the metals and water.

Most available hydrogen production techniques which are based on chemical decomposition of water are batch methods, whereby the reactants or reaction system needs to be rejuvenated or replaced due to the presence of contaminants or side products which poison the medium, thereby reducing hydrogen production volumes. Yang et al [1] proposed one such batch-wise process for hydrogen generation by reacting metals and additives, in water, under acidic and alkaline conditions.

### BACKGROUND ART

[1] Int. J. Energy Res. 2018; 1-9.

### GENERAL DESCRIPTION

The inventors of the technology disclosed herein have developed a methodology which involves a scalable, commercially viable, high yield and selective hydrogen gas production process that is not only environmentally friendly and can utilize waste materials, but most importantly is continuous. Processes of the invention provide an alternative to existing hydrogen gas production processes by utilizing a combination of scrap metal or waste metal and a Lewis acid in an aqueous medium under mild conditions, to enable an efficient, high yield and continuous production of hydrogen gas and side products, which are environmentally friendly and which may be used as raw materials in other industries.

In its most general aspect, the invention provides a process for producing hydrogen gas, the process comprising combining at least one metal and a Lewis acid in an aqueous medium under acidic conditions, to thereby produce the hydrogen gas.

The invention further provides a process for a batch production or a continuous production of hydrogen gas, the process comprising combining at least one metal and a Lewis acid in an aqueous medium under acidic conditions suitable for causing hydrogen gas evolution, whereby an acidity-neutralizing material is formed, the material is removed, thereby maintaining continuous production of hydrogen gas.

Further provided is a process for producing hydrogen gas from an aqueous medium, the process comprising
treating said aqueous medium with at least one metal and a Lewis acid, or providing an aqueous medium comprising at least one metal and a Lewis acid, under acidic conditions permitting evolution of hydrogen gas; and
removing from said medium an acidity-neutralizing material thereby allow for a continuous production of the hydrogen gas.

The at least one metal, provided in a zero valent state, is any stable metal of the Periodic Table of the Elements. The metal may be selected amongst transition metals, alkali metals and earth alkali metals. In some embodiments, the at least one metal is selected from transition metals.

The metal may be selected from iron (Fe), cobalt (Co), manganese (Mn), aluminum (Al), gallium (Ga), indium (In), magnesium (Mg) and zinc (Zn). The at least one metal may be provided in any degree of purity and in either a neat form or state or as an alloy of the metal (in a zero valent state) with another metal or in combination with one or more other non-metallic materials. The at least one metal may alternatively be provided in a metal oxide form. In some embodiments, the at least one metal is provided in pure form or as a single material.

Unlike existing processes for hydrogen gas production, which utilize pure or substantially pure metals, processes of the invention benefit from metal of low to medium purity. It is believed that existence of impurities or generally other known or unidentified materials along with the metal, may catalyze the reaction and may increase hydrogen gas production. Thus, the metal may be a “technical grade”, namely a composition of materials in an aggregated form or in a monolithic form or in an industrially assembled form that contains the metal (or metal oxide or metal alloy), whereby the metal may be separable from other components in the composition, but for reasons of cost-effectiveness and utility, such a separation is not necessary. In some cases, the technical grade metal may be a composition of materials in an aggregated form or in a monolithic form or in an industrially assembled form that comprises the metal (or metal oxide or metal alloy), and from which the metal cannot be easily separated. In other words, the metal (or metal oxide or metal alloy) may be any reusable metal provided in a form of metal scrap or any metal waste, which may comprise other materials in any amount or form. Such materials which may be present with the metal (or metal oxide or metal alloy) may be polymeric materials, carbonaceous materials or generally organic materials (such as colorants, dyes, stabilizers, antioxidation agents, etc), other metals, metal oxides, metal salts, etc. In such embodiments, the metal may be provided in the form of a low-grade metal or as a raw material derived from products containing the metal. The raw materials may be packaging materials, containers and cans, batteries, wires, cables, metal foils, utensils, coins, roofing elements, bottle caps, badges, electronics, fences, hinges, house and office fixtures, keychains, keys, metal plates, pipes, railings, construction elements, tools and others which comprise an amount of the at least one metal.

Generally, the metal used, e.g., metal of technical grade (or metal oxide or metal alloy), may be provided in any form, typically shredded or cut into pieces or as metal scrap such as swarf, turnings, chips, etc, for case and simplicity of use. The metal of low grade need not be pretreated to improve its state or to remove impurities or other components. The amount of metal in the total mass of materials used may vary and is selected based on the amount of the Lewis acid used. The technical grade metal may comprise at least 30 wt % of the at least one metal. In some embodiments, the amount of the at least one metal in the technical grade metal is 30 wt %, 40 wt %, 50 wt %, 60 wt %, 70 wt %, 80 wt %, or 90 wt %. In some embodiments, the amount of the at least one metal in the technical grade metal is between 10 wt % and 30 wt %.

In a similar fashion, the Lewis acid may also be of a technical grade and may contain impurities such as carbon, copper, brass, zinc, manganese and others that can catalyze hydrogen production reactions.

The Lewis Acid is one or more such materials that are each capable of being reduced in water in the presence of the at least one metal. The Lewis acid may or may not be a material comprising the same metal atom as the at least one metal used in the process. In some embodiments, however, the Lewis acid may be selected based on the at least one metal used. The Lewis acid may be selected from metal chlorides, metal bromides, metal fluorides, metal nitrates, metal sulfates and others, as well as non-metallic Lewis acids. Similarly, the Lewis acid may be selected amongst metal cations such as Cu⁺², Zn⁺², Fe⁺², Fe⁺³ and others. Non-limiting examples of such Lewis acids include ferric chloride (FeCl₃), ferric bromide (FeBr₃), aluminum chloride (AlCl₃), aluminum fluoride (AlF₃), carbon dioxide (CO₂), sulfur dioxide (SO₂), nitrogen dioxide (NO₂), boron trifluoride (BF₃), magnesium chloride (MgCl₂), zinc chloride (ZnCl₂), FeNO₃, FeSO₄ and others.

In some embodiments, the Lewis acid is a material comprising a metal atom that is the same as the at least one metal used in the process. In some embodiments, the Lewis acid is a material comprising an aluminum or an iron atom. In some embodiments, the Lewis acid is one or more of ferric chloride (FeCl₃), ferric bromide (FeBr₃), aluminum chloride (AlCl₃) and aluminum fluoride (AlF₃). In some embodiments, the Lewis acid is ferric chloride (FeCl₃) or aluminum chloride (AlCl₃).

In some embodiments, the Lewis acid is FeNO₃ or FeSO₄.

In some embodiments, an anhydrous Lewis acid is utilized.

In some embodiments, a hydrated Lewis acid is utilized, e.g., AlCl₃*6H₂O, FeCl₃*6H₂O, and others.

In some embodiments of the invention, the process for production of hydrogen gas comprises combining at least one metal and a Lewis acid comprising an atom identical to said at least one metal, wherein the oxidation state of the at least one metal is zero, and the oxidation state of the same metal in the Lewis acid is zero or is different from zero (e.g., the metal is positively charged).

In some emoluments, the at least one metal is Al and the Lewis acid comprises an Al atom (or ion).

In some emoluments, the at least one metal is Fe and the Lewis acid comprises an Fe atom (or ion).

In some emoluments, the at least one metal is Zn and the Lewis acid comprises a Zn atom (or ion).

In some emoluments, the at least one metal is Mg and the Lewis acid comprises a Mg atom (or ion).

In some emoluments, the at least one metal is Co and the Lewis acid comprises a Co atom (or ion).

In some emoluments, the at least one metal is Al and the Lewis acid comprises an Fe atom (or ion).

In some emoluments, the at least one metal is Fe and the Lewis acid comprises an Al atom (or ion).

The relative amounts of the at least one metal and of the Lewis acid may be varied based on, inter alia, the particular material and material combination used, presence of other materials in the reaction mixture, the conditions utilized and other varying factors or other considerations. In some embodiments, the amount of the at least one metal is in excess to the amount of the Lewis acid. In other embodiments, the amounts may be reversed; namely the amount of the Lewis acid may be greater than the amount of the at least one metal.

The ratio (w/w) between the metal and the Lewis acid may be between 1:10 to 1:1000. In some embodiments, the ratio metal:Lewis acid is 1:10, 1:15, 1:20, 1:25, 1:30, 1:35, 1:40, 1:45, 1:50, 1:60, 1:70, 1:80, 1:90, 1:100, 1:110, 1:120, 1:130, 1:140, 1:150, 1:160, 1:170, 1:180, 1:190, 1:200, 1:210, 1:220, 1:230, 1:240, 1:250, 1:300, 1:350, 1:400, 1:450, 1:500, 1:550, 1:600, 1:650, 1:700, 1:750, 1:800, 1:850, 1:900, 1:950, or 1:1000.

In some embodiments, the ratio between the metal and the Lewis acid may be between 10:1 to 1000:1. In some embodiments, the ratio metal:Lewis acid is 10:1, 15:1, 20:1, 25:1, 30:1, 35:1, 40:1, 45:1, 50:1, 60:1, 70:1, 80:1, 90:1, 100:1, 110:1, 120:1, 130:1, 140:1, 150:1, 160:1, 170:1, 180:1, 190:1, 200:1, 210:1, 220:1, 230:1, 240:1, 250:1, 300:1, 350:1, 400:1, 450:1, 500:1, 550:1, 600:1, 650:1, 700:1, 750:1, 800:1, 850:1, 900:1, 950:1, or 1000:1.

In some embodiments, the metal:Lewis acid ratio is between 1:100 and 100:1 or between 1:1000 and 1000:1.

Where the metal is iron and the Lewis acid is AlCl₃, the metal:Lewis acid ratio may be between 0.03 and 5 (or between 1:166). In some embodiments, where the metal is aluminum, the metal:Lewis acid ratio may be between 0.025 and 7.5 (or between 1:300).

Processes of the invention are typically carried out in water or in an environment containing water. The water used may be selected from tap water, reclaimed water, industrial grade water, sewage water, deionized (DI) water, brine (which may include desalination byproducts), upper ground salt-water and sea water. As the reactions are electrolytic in nature, sea water comprising high NaCl concentrations may be used as is and may contribute to accelerate rate of hydrogen production. In a similar manner, swamp water having low pH values (<4), sewage water containing high ion concentrations, mining waters having low pH values and other contaminated waters may be effectively used. In other words, in processes of the invention technical grade reactants as well as graywater as well as waters of low pH and high salt concentrations may be used.

Thus, the invention further provides a process for producing hydrogen gas in a batch-wise manner or in a continuous manner, the process comprising treating a combination of a metal-containing material (or a technical grade metal) and a technical grade Lewis acid in an aqueous medium selected from tap water, reclaimed water, industrial grade water, sewage water, deionized (DI) water, brine, upper ground salt-water and sea water, under conditions permitting evolution of hydrogen gas; and
optionally removing acidity-neutralizing materials formed, to thereby maintain hydrogen gas production.

In some embodiments, the process comprises
combining a metal-containing material (or a technical grade metal) and a technical grade Lewis acid in an aqueous medium selected from tap water, reclaimed water, industrial grade water, sewage water, deionized (DI) water, brine, upper ground salt-water and sea water, under conditions permitting evolution of hydrogen gas; and
optionally removing acidity-neutralizing materials formed, to thereby maintain hydrogen gas production.

In some embodiments, the aqueous medium is sea water.

In some embodiments, the aqueous medium is a water having a pH below 4, such as swamp waters or mining waters (e.g., used for extraction of minerals from the ground).

In some embodiments, the aqueous medium is sewage water containing high ion concentrations.

In some embodiments, the aqueous medium is contaminated waters or gray waters.

As noted herein, processes of the invention are carried out by first obtaining or combining the at least one metal and the Lewis acid in the aqueous medium. The two materials may be combined by adding each separately into the medium or by forming a mixture of the two and subsequently adding the mixture into the medium. As each of the materials may be provided in the form of a raw material, e.g., waste material or a technical grade material, as disclosed herein, each may or may not be pretreated separately or after combined to, e.g., separate therefrom contaminants and other materials that are not required for the production of hydrogen. In some embodiments, the at least one metal and the at least one Lewis acid are combined in the aqueous medium under conditions not sufficient to induce hydrogen production, namely under conditions different from those detailed herein, e.g., low temperatures and/or at neutral pH and/or weakly acidic conditions and/or basic conditions.

In some embodiments, the metal is added to a solution of the Lewis acid in water.

In some embodiments, the metal is provided in the form of solid particulates or grains or scrap. Where grains of a metal are used, the grains may be typically coarse and of an averaged size of at least 250 microns.

The reaction mixture may contain additional additive or reactants, as may be the case, that are useful in pushing the hydrogen production steps to the maximum or in limiting side reactions which reduce or limit hydrogen production. Such additives may be selected amongst oxidizing agents, catalysts, de-emulsifying agents, precipitation agents and others.

Non-limiting examples of oxidizing agents include oxygen gas or H₂O₂.

The de-emulsifying agent may be selected amongst citrate salts (such as monosodium citrate or trisodium citrate), ascorbic acid, EDTA, copper salts (such as CuCl₂) or benzoic acid.

The catalyst may be selected from carbonaceous materials such as carbon black and activated carbon, nickel oxides (NiOx), brass, zinc oxides (ZnOx), and metallic materials such as Al, Zn, Cu and others.

Typically, the “conditions permitting evolution of hydrogen gas”, or conditions under which hydrogen gas is produced may include one or more of the following:
a temperature between 4 and 85° C.; and
acidic conditions, e.g., a pH between −2 (negative 2) and 3.

In some embodiments, the temperature is between 4 and 85° C. In some embodiments, the temperature is around 4° C.±1° C. In some embodiments, the temperature is between 4° C. and room temperature (between 25 and 30° C., rt).

In some embodiments, the temperature is room temperature (rt). In some embodiments, the temperature is between rt and 50° C., between rt and 60° C., between rt and 70° C., between 30 and 50° C., between 35 and 50° C., between 4° and 50° C., between 30 and 60° C., between 4° and 70° C., between 40 and 80° C., between 5° and 60° C., between 5° and 70° C., between 5° and 80° C. or between 5° and 85° C.

In cases where the reaction is exothermic, it may be carried out without input of additional heat.

In some embodiments, the process is carried out in an aqueous medium at a pH between −2 and 3, or between −2 and 1.5, at room temperature.

In some embodiments, the pH is between pH=−2 (negative 2) and pH=0. In some embodiments, the pH is between pH=0 and pH=1.5. In some embodiments, the pH is between pH=0 and pH=3.

In some embodiments, the pH is different from a pH between 1 and 3. In some embodiments, the pH is between −2 and 1, or between −2 and 0.9.

In some embodiments, the pH is between −2 (negative 2) and −1.5 (negative 1.5), between −1.5 and −1, between −1 and −0.5, between −0.5 and zero, between zero and 0.5, between 0.5 and 1, or between 1 and 1.5, or between 1.5 and 2 or between 2 and 2.5 or between 2.5 and 3. in other embodiments, the pH is −2, −1.9, −1.8, −1.7, −1.6, −1.5, −1.4, −1.3, −1.2, −1.1, −1.0, −0.9, −0.8, −0.7, −0.6, −0.5, −0.4, −0.3, −0.2, −0.1, 0.0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9 or 3.

In some embodiments, the conditions include a temperature between 4 and 45° C. and a pH between −2 (negative 2) and 1.

As a person versed in the art would appreciate, where a negative pH is used, the pH has a calculated value that is below pH=zero. Such low pH values, including a pH of zero, indicate highly acidic conditions as known and used in the art.

In some embodiments, the process for producing hydrogen gas in a batch-wise manner or in a continuous manner comprises treating a combination of a metal-containing material (or a technical grade metal) and a technical grade Lewis acid in an aqueous medium at a temperature between 4 and 85° C. and at a pH between −2 (negative 2) and 3, to cause evolution or production of hydrogen gas;

wherein the aqueous medium is selected from tap water, reclaimed water, industrial grade water, sewage water, deionized (DI) water, brine, upper ground salt-water and sea water; and
optionally removing acidity-neutralizing materials formed, to thereby maintain hydrogen gas production.

In some embodiments, the conditions include a temperature between 4 and 45° C. and a pH between −2 (negative 2) and 1.

In some embodiments, the process comprises
combining a metal-containing material (or a technical grade metal) and a technical grade Lewis acid in an aqueous medium selected from tap water, reclaimed water, industrial grade water, sewage water, deionized (DI) water, brine, upper ground salt-water and sea water;
adjusting the aqueous medium to at a temperature between 4 and 85° C. and to a pH between −2 (negative 2) and 3 to cause evolution or production of hydrogen gas; and
optionally removing acidity-neutralizing materials formed, to thereby maintain hydrogen gas production.

In some embodiments, the conditions include a temperature between 4 and 45° C. and a pH between −2 (negative 2) and 1.

In some embodiments, the ratio (w/w) between the metal and the Lewis acid may be between 1:10 to 1:1000. In some embodiments, the ratio metal:Lewis acid is 1:10, 1:15, 1:20, 1:25, 1:30, 1:35, 1:40, 1:45, 1:50, 1:60, 1:70, 1:80, 1:90, 1:100, 1:110, 1:120, 1:130, 1:140, 1:150, 1:160, 1:170, 1:180, 1:190, 1:200, 1:210, 1:220, 1:230, 1:240, 1:250, 1:300, 1:350, 1:400, 1:450, 1:500, 1:550, 1:600, 1:650, 1:700, 1:750, 1:800, 1:850, 1:900, 1:950, or 1:1000.

In some embodiments, the ratio between the metal and the Lewis acid may be between 10:1 to 1000:1. In some embodiments, the ratio metal:Lewis acid is 10:1, 15:1, 20:1, 25:1, 30:1, 35:1, 40:1, 45:1, 50:1, 60:1, 70:1, 80:1, 90:1, 100:1, 110:1, 120:1, 130:1, 140:1, 150:1, 160:1, 170:1, 180:1, 190:1, 200:1, 210:1, 220:1, 230:1, 240:1, 250:1, 300:1, 350:1, 400:1, 450:1, 500:1, 550:1, 600:1, 650:1, 700:1, 750:1, 800:1, 850:1, 900:1, 950:1, or 1000:1.

In some embodiments, the metal:Lewis acid ratio is between 1:100 and 100:1 or between 1:1000 and 1000:1.

Using a combination of the metal and the Lewis acid enables a cyclic reaction which continuously maintains the acidic conditions without needing to supplement the reaction mixture with further additives. For example, in a production process utilizing aluminum as the metal and AlCl₃ as the Lewis acid, the aluminum ions are recycled during the process, as depicted below, thus maintaining the low pH values required.

To ensure continuous production of hydrogen gas or at least for the purpose of maintaining a low or stable pH value, whereby an acidity-neutralizing material is formed during the hydrogen gas production, the acidity-neutralizing material may be at least partially removed from the reaction mixture/medium by any means known in the art. Depending on the metal and the Lewis acid used, the acidity-neutralizing material may vary in composition and amount. In most general terms, the “acidity-neutralizing material” is a byproduct of the reaction which presence increases the pH and may thus influences the rate of hydrogen gas production and also on the continuity of hydrogen production. The acidity-neutralizing material need not be a material that neutralizes the aqueous medium or increases the pH to 7, but rather increase the pH by any degree or any number of pH units or fractions thereof. The acidity-neutralizing material may increase the pH of the reaction to a pH exceeding the pH range suitable for carrying out the reaction, namely to a pH above −2 (negative 2) and 3.

Typically, the acidity-neutralizing material is formed as a basic species or a hydroxide salt or a weak base metal oxide that is derived from the reaction between the metal and the Lewis acid, in the aqueous medium, or from any contaminant that may be present with the technical grade materials. For example, where the metal is aluminum and/or the Lewis acid is aluminum chloride, the acidity-neutralizing material may be any aluminum hydroxide species which is formed. The aluminum hydroxide species may be, for example, any one or more of Al₅Cl₃(OH)₁₂*7.5(H₂O), Al₅Cl₃(OH)₁₂*4(H₂O), Al₁₀Cl₄(OH)₂₆*X(H₂O), Al₁₀C₁₃(OH)₂₇*13(H₂O), Al₁₃Cl₁₅(OH)₂₄*37(H₂O), Na₂Al₂O₄, alpha Al₂O₃, theta Al₂O₃, gamma Al₂O₃, amorphous alpha Al₂O₃, AlOOH*XH₂O. AlCl₂OH*XH₂O, AlCl(OH)₂*XH₂O, and others, wherein X defines the number of water molecules in a hydrate, and may be selected as known in the art, e.g., x may be 1, 2, 3, 4, 5, 6, etc or any fraction thereof. Similar acidity-neutralizing materials may be formed in the presence of other metals and/or Lewis acids.

The acidity-neutralizing material may be a water-insoluble material or a material having a limited solubility in the aqueous reaction medium. As such, the material tends to precipitate and can be removed. However, for neutralizing or diminishing the effect of the acidity-neutralizing material on the pH of the medium, in some cases, it is sufficient to adsorb the material onto a functional material that can bind to, associate with, or adsorb the acidity-neutralizing material. Thus, the acidity-neutralizing material may be removed mechanically, e.g., by decantation or filtration or chemically by using an adsorbent material, that is inert under the reaction conditions. The adsorbing material used for the chemical separation of the acidity-neutralizing material(s) may chemically or physically interact with the acidity-neutralizing material(s). It is not necessary to have chemical separation involve any one or more chemical association, i.e., bond forming.

Non-limiting examples of such adsorbing materials include porous materials; zeolites; carbonaceous materials such as activated carbon and carbon molecular sieves; clay; chelators; porous ceramic bodies such as crystallites of alumina, zirconia or titania; and others.

In some embodiments, the adsorbing material is a zeolite selected from (Si/Al)₅O₁₀ typically as fibrous zeolites, gonnardite, natrolite, mesolite, paranatrolite, scolecite, tetranatrolite, edingtonite, kalborsite, thomsonites, analcime, leucite, pollucite, wairakite, harmotome, phillipsites, amicite, gismondine, garronite, gobbinsite, chabazites, herschelite, willhendersonite, faujasites, maricopaite, mordenite, offretite, wenkite, clinoptilolite, heulandites, barrerite, stellerite, stilbites, cowlesite, pentasil, tschernichite and others.

In some embodiments, the adsorbing material is activated carbon or carbon molecular sieves.

In some embodiments, the adsorbing material is clay.

In some embodiments, the adsorbing material is a porous ceramic material such as crystallites of alumina, zirconia or titania.

In some embodiments, the adsorbing material is a porous material such as molecular sieves, clay and porous ceramic materials.

Processes of the invention, as disclosed herein may comprise use of a combination or forming a combination or combining at least one metal and a Lewis acid in an aqueous medium under acidic conditions sufficient to cause evolution or production of hydrogen gas and removing an acidity-neutralizing material, as defined, mechanically e.g., by decantation or filtration, or chemically, e.g., by using an adsorbent material, to thereby maintain continuous production of the hydrogen gas.

Alternatively, the step of removing the acidity-neutralizing material, as defined, may be achieved by decanting the material, by filtering out the material, or by adsorbing the material.

A process may similarly comprise
treating an aqueous medium with at least one metal and a Lewis acid, or providing an aqueous medium comprising at least one metal and a Lewis acid, under acidic conditions permitting evolution of hydrogen gas; and
removing from said medium acidity-neutralizing materials, as defined, mechanically e.g., by decantation or filtration, or chemically, e.g., by using an adsorbent material, to thereby allow a continuous production of the hydrogen gas.

Alternatively, the step of removing the acidity-neutralizing material, as defined, may be achieved by decanting the material, by filtering out the material, or by adsorbing the material.

In a process for producing hydrogen gas in a batch-wise manner or in a continuous manner, a combination of a metal-containing material (or a technical grade metal) and a technical grade Lewis acid may be treated in an aqueous medium at a temperature between 4 and 85° C. and at a pH between −2 (negative 2) and 3, to cause evolution or production of hydrogen gas;
wherein the aqueous medium is selected from tap water, reclaimed water, industrial grade water, sewage water, deionized (DI) water, brine, upper ground salt-water and sea water; and
   removing acidity-neutralizing materials, as defined, that are formed, mechanically, e.g., by decantation or filtration, or chemically, e.g., by using an adsorbent material, to thereby maintain hydrogen gas production.

Alternatively, the step of removing the acidity-neutralizing material, as defined, may be achieved by decanting the material, by filtering out the material, or by adsorbing the material.

In some embodiments, the process comprises
combining a metal-containing material (or a technical grade metal) and a technical grade Lewis acid in an aqueous medium selected from tap water, reclaimed water, industrial grade water, sewage water, deionized (DI) water, brine, upper ground salt-water and sea water;
adjusting the aqueous medium to at a temperature between 4 and 85° C. and to a pH between −2 (negative 2) and 3 to cause evolution or production of hydrogen gas; and
removing acidity-neutralizing materials formed mechanically by decantation or filtration or chemically by using an adsorbent material, to thereby maintain hydrogen gas production.

Alternatively, the step of removing the acidity-neutralizing material, as defined, may be achieved by decanting the material, by filtering out the material, or by adsorbing the material.

Where mechanical means are used for removing the acidity-neutralizing materials, the removal may be at any stage during the process, for example, at a time when the amount of materials exceeds a certain threshold amount; or may be continuous.

Processes of the invention may be carried out in a suitable reactor that is configured and operable in a single batch mode or in a continuous production mode. The reactor which is configured for holding a liquid medium, may be provided with an inlet or inlet assembly configured for introducing into the reactor a liquid medium and a plurality of reactants, e.g., the metal, Lewis acid and additives, and an outlet or an outlet assembly for intermittent or continuous removal and collection of the generated hydrogen gas. The reactor may further be equipped with a heating assembly or a heat exchange unit.

A system comprising the reactor may further comprise one or more additional reactors and a control unit configured to operate the reactor or the two or more reactors in a batch, semi batch or continuous mode.

The reaction may proceed with any metal, as defined herein, with any Lewis acid, as defined herein. In some embodiments, the Lewis acid is a salt form of the metal. For example, where the metal is iron, the Lewis acid will be a salt form of iron. In some embodiments, the Lewis acid is a salt form of a metal different from the at least one metal used in the combination. For example, where the metal is iron, the Lewis acid may be a salt form of aluminum.

The following provides non-limiting exemplary embodiments of metal-Lewis acid systems used according to the invention in a continuous or batch-wise hydrogen gas producing processes.

Exemplary embodiments 1: The at least one metal is Fe and the Lewis acid is FeCl₃.

Without wishing to be bound by theory, metallic iron is reacted with ferric chloride in an aqueous environment to produce hydrogen gas according to the following reactions. As shown in equation (1) below, the source of Fe⁺³ ions is in the disassociation of FeCl₃ in the aqueous solution. Upon addition of FeCl₃, at a concentration ranging from 20 to 40 wt %, as depicted in equations (2) and (3), an acidic medium is obtained having a low (e.g., negative) pH.

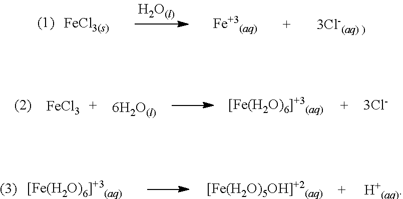

Reduction of protons evolved according to equation (3) by the metal, e.g., iron, proceeds according to equation (4) to produce hydrogen gas:

Fe₍ₛ₎+2H⁺_{(aq)}→Fe⁺²_{(aq)}+H_{2(g)}. (4)

Fe⁺³ ions that are produced in the process, as depicted, for example, in equation (1) are reduced to Fe⁺² by the metallic iron, as shown in equation (5) below. As this reaction is a competing reaction that reduces hydrogen production yield per gram of metal iron, an oxidizing agent may be added to the solution containing the Fe⁺² ions to force their oxidation back to Fe⁺³ ions, thereby lowering the pH and permitting effective production of hydrogen gas. The oxidizing agent may be any such agent known in the art, that does not directly interact (e.g., by complexation or chemical association) with the metal or ions of the metal in solution and does not in any way affect hydrogen evolution. Non-limiting examples of such oxidizing agents include oxygen gas or H₂O₂.

Fe₍ₛ₎+2Fe⁺³_{(aq)}→3Fe⁺²_{(aq)} (5)

4Fe⁺²_{(aq)}+O_{2(g)}+4H⁺_{(aq)}→4Fe⁺³_{(aq)}+2H₂O₍ₗ₎. (6)

The dissolution of anhydrous FeCl₃ in water is highly exothermic. By co-adding the (anhydrous) FeCl₃ and the Fe metal, the heat emitted is exhausted to accelerate reduction of the H⁺ ions and accordingly hydrogen production rate.

In cases where formation of an emulsion of the Lewis acid, e.g., Fe(OH)₃, in the aqueous solution, is to be prevented or limited, a de-emulsifier or an additive such as a citrate salt (e.g., monosodium citrate or trisodium citrate), ascorbic acid, EDTA, CuCl₂ or benzoic acid, may be added. Since these additives are more basic (or less acidic) than [Fe(H₂O)₆]³⁺ and as their addition may reduce the amount of protons and thus limit hydrogen production, their use may be limited.

Carbon additives, such as activated carbon, may be used as catalysts to accelerate the reaction substantially. Thus, in cases where the at least one metal or the Lewis acid utilized is contaminated with carbon impurities, a significant improvement in the production of hydrogen is observed. In addition, Al, brass, Zn and Cu were observed to similarly accelerate the reactions.

In a similar manner, using metallic aluminum and AlCl₃, in an aqueous medium, produces hydrogen gas under similar conditions.

### Exemplary Embodiments 2: The at Least One Metal is Al and the Lewis Acid is AlCl₃

In a typical reaction, Al⁺³ ions dissociate from the AlCl₃ in the aqueous solution as shown in equation (7). Upon addition of AlCl₃ at a concentration ranging from 20 to 40 wt %, as depicted in equations (8) and (9), an acidic medium is obtained having a low (e.g., negative) pH.

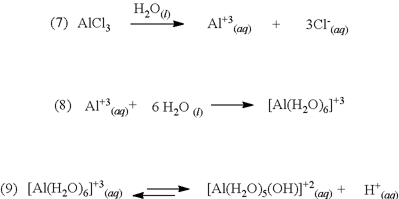

Production of protons, according to equation (9), is typically followed by two additional proton-producing steps (10) and (11), but their contribution is limited.

[Al(H₂O)₅(OH)]⁺²_{(aq)}+H₂O₍ₗ₎⇄[Al(H₂O)₄(OH)₂]⁺_{(aq)}+H⁺_{(aq)} (10)

[Al(H₂O)₄(OH)₂]⁺_{(aq)}+H₂O₍ₗ₎⇄Al(H₂O)₃(OH)_{3(aq)}+H⁺_{(aq)}. (11)

Metal aluminum may be provided in an oxidized form, e.g., in the form of alumina (Al₂O₃). The native oxide layer may be removed by the protons formed according to the reactions above, resulting in the acidic [Al(H₂O)₆]⁺³ complex, as shown in the sequential steps depicted in equations (12) and (13) below.

Al₂O₃₍ₛ₎+6H⁺_{(aq)}→2Al⁺³_{(aq)}+3H₂O₍ₗ₎ (12)

Al⁺³_{(aq)}+6H₂O₍ₗ₎→[Al(H₂O)₆]⁺³_{(aq)}⇄[Al(H₂O)₅(OH)]⁺²_{(aq)}+H⁺_{(aq)}. (13)

Production of hydrogen gas ensues when alumina-free aluminum metal contact water, as shown in equation (14).

Al(s)+3H₂O₍ₗ₎→Al(OH)₃+1.5H_{2(g)} (14)

A low pH, production of hydrogen gas is facilitated by reduction of protons by solid aluminum, as shown in equation (15).

Al₍ₛ₎+3H⁺_{(aq)}→Al⁺³_{(aq)}+1.5H_{2(g)}. (15)

As in the case of ferric chloride, the dissolution of (anhydrous) AlCl₃ in water is highly exothermic. By co-adding the AlCl₃ and the aluminum metal, the emitted heat is exhausted to accelerate reduction of the H⁺ ions and accordingly hydrogen production rate.

To avoid precipitation of AlCl₃ as aluminum chloride hexahydrate, or polymerization thereof into poly-aluminum chloride (PAC) or into basic poly-aluminum chloride (BAC), the reaction mixture is typically diluted with water or with an aqueous solution having acidic pH (such as an HCl solution). Similarly, when the solution is saturated with aluminum ions and as the pH begins to increase, to avoid generation of aluminum species such as aluminum hydroxide Al(OH)₃, aluminum-oxy-hydroxide (AlOOH), alumina (Al₂O₃), aluminum chloride hydroxide (AlCl(OH)₂) or aluminum di-chloride hydroxide (AlCl₂OH), the solution is similarly diluted.

### Exemplary Embodiments 3: The at Least One Metal is Aluminum and the Lewis Acid is FeCl₃

As with the reactions above, the source of Fe⁺³ ions is in the disassociation of FeCl₃ in the aqueous solution, shown in equation (16). Upon addition of FeCl₃, at a concentration ranging from 20 to 40 wt %, as depicted in equations (17) and (18), an acidic medium is obtained having a low (e.g., negative) pH.

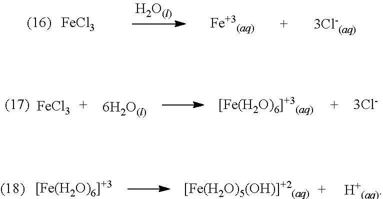

Peeling off of the native alumina (Al₂O₃) passivation layer covering the aluminum grains is achievable by the protons formed, resulting in the formation of acidic [Al(H₂O)₆]⁺³ complex through the reaction shown in equation (19) and the subsequent reaction shown in equation (20).

Al₂O₃₍ₛ₎+6H⁺_{(aq)}→2Al⁺³_{(aq)}+3H₂O₍ₗ₎ (19)

Al⁺³_{(aq)}+6H₂O₍ₗ₎→[Al(H₂O)₆]⁺³_{(aq)}⇄[Al(H₂O)₅(OH)]⁺²_{(aq)}+H⁺_{(aq)}. (20)

The proton generation step shown in equation (20) is usually followed by two additional proton generation steps of limited contributions (equations (21) and (22)).

[Al(H₂O)₅(OH)]⁺²_{(aq)}⇄[Al(H₂O)₄(OH)₂]⁺_{(aq)}+H⁺_{(aq)} (21)

[Al(H₂O)₄(OH)₂]⁺_{(aq)}⇄Al(H₂O)₃(OH)_{3(aq)}+H⁺_{(aq)} (22)

Production of hydrogen gas ensues when alumina-free aluminum metal contact water, as shown in equation (23).

Al(s)+3H₂O₍ₗ₎→Al(OH)₃+1.5H_{2(g)} (23)

A low pH production of H₂ gas is facilitated by reduction of protons by solid aluminum, as shown in equation (24).

Al₍ₛ₎+3H⁺_{(aq)}→Al⁺³_{(aq)}+1.5H_{2(g)}. (24)

In addition, solid Al interacts with Fe⁺³ ions, reducing them to Fe₍ₛ₎, as shown in equation (25).

Al₍ₛ₎+Fe⁺³_{(aq)}→Al⁺³_{(aq)}+Fe₍ₛ₎. (25)

As with other combinations of a metal and a Lewis acid according to the invention, various agents (additives) may be used in accelerating the rate of hydrogen production. Non-limiting examples are shown in Table 1 below. While these agents are demonstrated in respect of a particular metal/Lewis acid combination, the agents may be used in any combination of the two according to the invention.

TABLE 1
reactions of Al in FeCl₃ solution

| | | | | | | | Emitted |
|---|---|---|---|---|---|---|---|
| | | | | | | Emitted | H₂ per |
| | FeCl₃ | Al | | | Emitted | H₂, | 1 gr Al, |
| Solution | concentration | (gr) | Al type | Reaction | H₂. | ml/min/gr | ml/min/gr |
| FeCl₃ | 20% | 1 | UBC | RT., no | 590 | 1.0 | 1 |
| technical | | | | stirring | | | |
| solution | | | | | | | |
| 40% | | | | | | | |
| FeCl₃ | 20% | 1.05 | Ground | RT., no | 340 | 15.5 | 14.8 |
| technical | | | dirty UBC | stirring | | | |
| solution | | | | | | | |
| 40% | | | | | | | |
| FeCl₃ | 20% | 1.01 | Nitric acid | RT., no | 430 | 130 | 129 |
| technical | | | cleaned | stirring | | | |
| solution | | | ground | | | | |
| 40% | | | UBC | | | | |
| FeCl₃ | 20% | 1.03 | Aluminum | RT., no | 430 | 344 | 334 |
| technical | | | foil | stirring | | | |
| solution | | | | | | | |
| 40% | | | | | | | |
| FeCl₃ | 20% | 1.28 | Aluminum | RT., no | 820 | 3780 | 2950 |
| technical | | | foil | stirring | | | |
| solution | | | | | | | |
| 40% | | | | | | | |
| containing | | | | | | | |
| brass form | | | | | | | |
| used | | | | | | | |
| cartridge | | | | | | | |
| case | | | | | | | |
| FeCl₃ | 20% | 1 | Aluminum | RT., no | 1400 | 4200 | 420 |
| technical | | | foil | stirring | | | |
| solution | | | | | | | |
| 40% waste | | | | | | | |

### Exemplary Embodiments 4: The at Least One Metal is Iron and the Lewis Acid is AlCl₃

In cases where metallic iron is reacted with aluminum chloride in an aqueous environment, the first reaction involves dissociation of the AlCl₃ in aqueous solution according to equation (26) below.

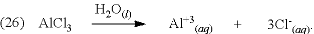

Upon addition of AlCl₃ at a concentration ranging from 20 to 40 wt %, as depicted in equations (27) and (28), an acidic medium is obtained having a low (e.g., negative) pH.

Al⁺³_{(aq)}+6H₂O₍ₗ₎→[Al(H₂O)₆]⁺³ (27)

[Al(H₂O)₆]⁺³_{(aq)}⇄[Al(H₂O)₅(OH)]⁺²_{(aq)}+H⁺_{(aq)}. (28)

Then, reduction of protons by the solid iron ensues, according to equation (29) below.

Fe₍ₛ₎+2H⁺_{(aq)}→Fe⁺²_{(aq)}+H_{2(g)}. (29)

Since the pH of the medium containing Fe⁺² ions is far higher (less acidic) than of a medium containing Fe⁺³ or Al⁺³ ions (pH˜5 as compared to pH˜0), oxidation of the Fe⁺² ions to Fe⁺³ ions, in the presence of an oxidizing agent (such as oxygen (equation (5) or hydrogen peroxide), reestablished the high acidity (low, or negative pH) values required to maintain the metal hydrolysis process and hydrogen production.

(5)4Fe⁺²_{(aq)}+O_{2(g)}+4H⁺_{(aq)}→4Fe⁺³_{(aq)}+2H₂O₍ₗ₎. (30)

Although presence of Fe⁺³ ions facilitates the maintenance of low pH values in solution, it may also induce formation of a Fe(OH)₃ and cause its precipitation when the pH increases. Preventing Fe(OH)₃ from forming an emulsion is achieved by a utilizing a de-emulsifying agent, as disclosed herein.

The invention further provides a process for the continuous production of hydrogen gas, the process comprising combining aluminum and aluminum chloride, in an aqueous medium, under acidic conditions, (continuously) removing from said aqueous medium an acidity-neutralizing material that forms, to thereby continuously produce hydrogen gas.

The invention also provides a process for the continuous production of hydrogen gas, the process comprising combining aluminum and aluminum chloride, in an aqueous medium, at a pH between −2 and 3, (continuously) removing from said aqueous medium an acidity-neutralizing material that forms, to thereby continuously produce hydrogen gas.

The invention further provides a process for the continuous production of hydrogen gas, the process comprising combining a material comprising aluminum and aluminum chloride, in an aqueous medium, under acidic conditions, (continuously) removing from said aqueous medium an acidity-neutralizing material that forms, to thereby continuously produce hydrogen gas.

In some embodiments, the material that comprises aluminum is any low-grade aluminum or an object containing the metal, as detailed herein.

In some embodiments, the process comprises removal of sacrificial materials separated from the material comprising the aluminum. The sacrificial materials may be plastics, other metals, colorants, paper materials and others.

In some embodiments, the reaction is carried out at a temperature between 4 and 85° C.

In some embodiments, the acidity-neutralizing material that forms is selected from Al₅Cl₃(OH)₁₂*7.5(H₂O), Al₅Cl₃(OH)₁₂*4(H₂O), Al₁₀C₁₄ (OH)₂₆*X (H₂O), Al₁₀Cl₃(OH)₂₇*13(H₂O), Al₁₃Cl₁₅ (OH)₂₄*37(H₂O), Na₂Al₂O₄, alpha Al₂O₃, theta Al₂O₃, gamma Al₂O₃, amorphous alpha Al₂O₃, AlOOH*XH₂O, AlCl₂OH*XH₂O, AlCl(OH)₂*XH₂O, and others, wherein X defines the number of water molecules in a hydrate.

In some embodiments, the pH-neutralizing material mechanically or chemically removed.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a graph showing pH changes along a reaction.

FIG. 2 is a graph of Flow vs. Time.

### DETAILED DESCRIPTION OF EMBODIMENTS

### I. Reaction of Fe₍ₛ₎ in FeCl₃ Solution

### Example 1

Iron grains, 1-10 gr. (usually 98% coarse grains, or 99+% 250 microns fine powder) were introduced to a 20-100 cc water solution containing 10-40% w/w FeCl₃ (ratio amount, wt, of Fe to FeCl₃ solution being between 0.025-5).

After several minutes H₂ evolution was noted. Reactions lasted from 5 minutes to about an hour. Average reaction flow rates were 1.5 ml/gr/min at R.T. with stirring to 120 ml/gr/min at R.T., when anhydrous FeCl₃ and Fe grains were introduced together to the solution.

The initial temperatures ranged from 17 to 80° C., due to the exothermic nature of the reaction. No external heat was introduced.

The pH values increased from −1 to 5.

### Example 2

A Buchner flask (125/250 ml) was used for the reaction. The gas was collected through a rubber tube connected to an inverted water filled 2-liter plastic bottle placed upside down with head dipped in a water vassal. The gas was received in the bottle and quantified.

The flask was filled with 80 ml of technical grade FeCl₃ solution (20% w/w concentration) having a dark red color due to the high concentration of the Fe⁺³ ions and negative pH values.

5.5 gr. of Fe grains (of 98% purity) were introduced into the solution one gr. at the time. After the first gr. was added the flask warmed up and the solution started to change color.

In a typical reaction about 250 ml of hydrogen will be generated over 7-25 minutes and will result in an increase in the solution temperature from room temperature to 60-70° C. Ideally, 436 cc of hydrogen should be generated for each 1 gr. of Fe reducing the acidic solution H⁺ ions. In practice only 250 ml are obtained for 5.5 gr. of Fe₍ₛ₎. The maximal production rate observed was 20 ml/min/gr.

Additional experiments using the same FeCl₃ solution can be run by replacing the Fe with Al after the first round. Al acts directly with the water and is less affected by the pH values or the presence of precipitates.

The reducing agent for the described process, namely iron, can be used from different sources and in different purity grades. It was found that better hydrogen yields were achieved by coarse and less pure Fe grains (98%) as compared with pure (99+%) and smaller (250 microns) grains.

During the experiments several FeCl₃ solutions of various sources were tested with different characteristics described. These are listed in Table 2 below.

TABLE 2
FeCl₃ solutions and their characteristics

| Substance and | | | Mv | | Dissolving |
|---|---|---|---|---|---|
| concentration | Composition | pH | Redox potential | Conductivity | heat |
| FeCl₃ | 98% | <0 | 411 | 78.9 | high |
| Anhydr | | | | | |
| 40% in water | | | | | |
| FeCl₃* 6 H₂O | 97% | 0.66 | 374 | 80.8 | low |
| 40% in water | | | | | |
| FeCl₃ Technical | 0.25% FeCl₂ | <0 | 509 | 51.2 | — |
| solution | 0.6% HCl | | | | |
| 40% in water | 0.5% | | | | |
| | insoluble | | | | |
| | materials | | | | |
| FeCl₃ Technical | 0.25% FeCl₂ | <0 | 459 | 16.8 | — |
| solutiuon, waste | 0.6% HCl | | | | |
| 40% in water | 0.5% | | | | |
| | insoluble | | | | |
| | materials, | | | | |
| | trace amounts | | | | |
| | of Zn, Cu and | | | | |
| | Mn | | | | |
| Self-produced FeCl₃ | Made of steel | <0 | 515 | 24.8 | — |
| 40% in water | wool and HCl | | | | |

The solid anhydrous and the hexahydrate FeCl₃ have high ionic conductivity and salinity relative to the other FeCl₃ solution used. The solid anhydrous FeCl₃ has the highest dissolving heat resulting in a solution temperature reaching 75° C. The hexahydrate FeCl₃ has a much lower dissolving temperature heat and as a result the solution temperature is lower. In the technical solution there are traces of insoluble materials, probably anticoagulants as well as FeCl₂ and HCl.

The noteworthy reduction in conductivity of both the FeCl₃ technical waste solution and the self-produced FeCl₃ solutions imply that their ionic concentrations was relatively low. Yet, the pH and redox potential values are close to the ones of the solid FeCl₃ based solutions. Optional explanation for the relatively low conductivity could be that higher HCl and FeCl₂ concentrations leading to an increase in chloride ions pushing the solution balance toward the FeCl₄⁻ ion through FeCl₃+Cl⁻→FeCl₄⁻, resulting in one heavy ion instead of 5 separate ions—4 chlorine ions and 1 ferric ion (Fe⁺³).

### II. Reaction of Al in AlCl₃—Example 1

Pre-process cleaning: A beverage can was immersed in 50% HNO₃ solution for 24 hr. to separate the plastic outer layer from the aluminum can.

To an Erlenmeyer containing 50 ml, 20% w/w solution of AlCl₃ (pH=1.16), 0.5 gr rubbed clean Aluminum can was added. The solution was heated to 50° C. for 5:25 hours. 650 cc H₂ gas was produced. Additional amounts of Al were added periodically and gas was collected.

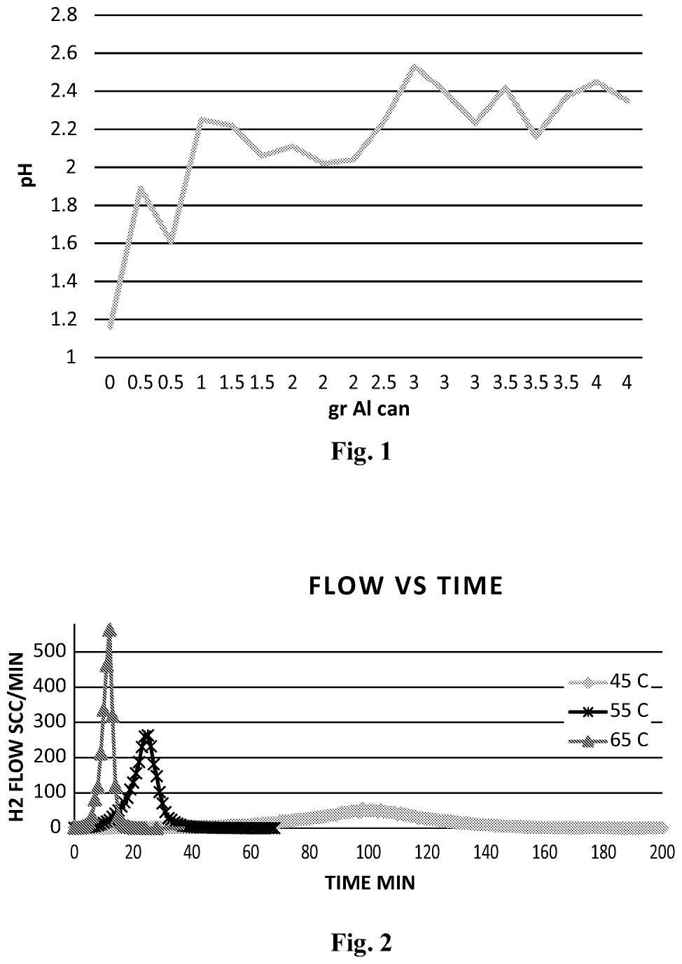

After 8 additions of 0.5 gr Al (clean rubbed beverage can pieces), the solution was saturated, and less H₂ gas was produced. Few Solid Al pieces were left in the solution. The solution was filtered. pH after filtration was 2.43. the pH changes along the reaction is according to the graph in FIG. 1.

A total amount of 5550 cc H₂ gas was produced as compared to the theoretical value of 5440 cc. The difference might be because of errors in measurements of Al weight or H₂ gas produced

### III. Reaction of Al and AlCl₃—Example 2

Quantities of 1-15 gr. of Al(99.9% wire, 99% granules, beverage cans and Aluminum foil) were added to 20-80 cc water solution containing 10-40% w/w solid AlCl₃. w/w ratio of Al to AlCl₃ was 0.025-7.5.

H₂ evolution started almost immediately after the introduction of Al and reaction duration ranged from several minutes to about two hours. Average reaction flow rates were 2.2 ml/gr/min for aluminum wire at rt to 140 ml/gr/min for aluminum foil at rt.

Initial reaction temperatures were 17-80° C., while its exothermic nature increased solution temperature to about 70° C. even if the process was carried at room temperature.

In accordance with reaction progress, pH values increased from −1 to about 4.

It is possible to partition the aluminum water reaction into three stages based on the reaction dynamics: induction stage, production stage where most of the hydrogen is obtained and the decay stage. It is possible to perform different reaction stages in different chemical environments.

Specifically, the induction stage (the hydration of the aluminum oxide layer) can proceed in AlCl₃/FeCl₃ medium that can be replaced to H₂O media once the production stage is reached. This procedure was proven beneficial to the by-product catalyst separation stage while maintaining high overall reaction rates.

To have a better understanding of the kinetics and dynamics of the set of reactions mentioned above, a set of batch reactions were performed as follows.

300 ml of 35% w/v AlCl₃ solution was placed in a sealed jacketed reaction vessel equipped with continuous Temperature and pH monitoring. The evolved gas flow was quantified both by a hydrogen mass flow meter and a micro gas chromatograph monitors its composition.

In each experiment 2 gr of aluminum foil were added to the reaction vessel which was under constant external fluid circulation at a set temperature in the range 35-65° C.

In all runs, hydrogen yield was around 100% (95%-102%) and the only components detected in the gas stream were hydrogen and residual air. No other components were detected by gas chromatography or VOC photo ionization detection.

Both hydrogen evolution and the alumina hydration (reactions 4 and 5) follow an Arrhenius like behavior. According to the experiments and kinetic model this small lab scale setup is cable to produce up to 100 gr of high purity hydrogen/day at continuous operation mode.

The reducing agent for the described process, namely aluminum, can be used from different sources and in different purity grades. Surprisingly, it has been found that certain secondary materials provide improved results in comparison to other sources of aluminum. Improved results are in terms of conversion, yield and product purity. For example, 0.5 gr of pure Aluminum granules and wire gave only poor hydrogen ejection rates (1 ml/min for the wire and 2.9 ml/min for the granules) as compared to 70 ml/min for the same amount of aluminum foil and 38 ml/min for beverage cans.

It is possible to partition the aluminum water reaction into three stages based on the reaction dynamics: induction stage, production stage where most of the hydrogen is obtained and the decay stage It is possible to perform different reaction stages in different chemical environments.

Specifically, the induction stage (the hydration of the aluminum oxide layer) can proceed in AlCl₃/FeCl₃ medium that can be replaced to H₂O media once the production stage is reached. This procedure can prove to be beneficial to the by-product catalyst separation stage while maintaining high overall reaction rates.

### IV. Reaction of Fe in AlCl₃ Solution

Buchner flask (an Erlenmeyer flask with hose barb) of 100/125/250 ml was commonly used for the reaction. Gas was collected through a rubber tube connected to a water filled 1.5-liter plastic bottle placed upside down with head dipped in a water vessel. The gas emitted by the reaction enter the bottle replacing the water allowing thus the measurement of emitted gas quantity

The flask is filled with 50 ml solution of AlCl₃ anhydrous (w/w=30-35%). The initial pH of the solution is negative.

Fe grains (98%) are introduced to the solution at 1 gr rounds.

At room temperature the reaction is rather slow but the yield is constant at 400 ml hydrogen after 2-3 hours reaction (see table 1). Ideally each gr of Fe₍ₛ₎ should yield 436 ml of hydrogen, therefore the efficiency is around 90%.

TABLE 3
hydrogen production by Fe reaction in AlCl₃ solution

| Rate | Rate | Emitted | | reaction | Fe | | |
|---|---|---|---|---|---|---|---|
| (ml/min/gr) | (ml/min) | H₂ (ml) | | temp. | (gr) | Conc. | Solution |
| 1.8 | 1.8 | 1350 | in | room | 4.12 | 32% | AlCl₃ |
| | | 750 | min | | | | Anhydr. |
| 3.3 | 3.3 | 400 | in | 63° C. | 1.04 | 33% | AlCl₃ |
| | | 120 | min | | | | Anhydr. |
| 3 | 3 | 440 | in | 50° C. | 0.87 Fe + 0.12 | 33% | AlCl₃ |
| | | 145 | min | | Al foil | | Anhydr. |

After each gr of Fe added the solution becomes greenish due to the Fe⁺² ions growing concentration. The Fe⁺² ions are less acidic than the Fe⁺³ ions and thus the pH will increase up to 2-2.5 values (or 5 with ferrous ions).

After adding 5-6 gr of Fe to the solution a gelatinlike precipitation will start forming. XRD results of the precipitation revealed a phase of AlCl₃*6H₂O as a result of water losses and reaching the solubility limit of AlCl₃. Some experiments revealed in addition an amorphous phase of alumina.

### V. Reaction of Fe in AlCl₃

Quantities of 1-10 gr. of Fe (usually 98% coarse grains and sometimes 99+% 250 microns fine powder) were added to 20-80 cc water solution containing 10-40% w/w solid AlCl₃ w/w ratio of Fe to AlCl₃ quantities was 0.03-5.

The first H₂ bubbles emerged 5-30 minutes after the introduction of Fe₍ₛ₎ and reaction duration extended from 15 minutes to about four hours depending on warming temperatures.

Reaction flow rate ranged from 1.8 ml/gr/min to about 5.2 ml/gr/min both at R.T.

Initial reaction temperatures were 17-75° C., while its exothermic nature increased solution temperature to about 70° C. even if the process was carried at room temperature.

In accordance with reaction progress pH values increased from −1 to 5.

The reducing agent for the described process, namely iron, can be used from different sources and in different purity grades. It was found that better hydrogen yields were achieved by using coarse and less pure Fe grains (98%) than by purer (99+%) and smaller (250 microns) grains.

### VI. Reaction of Al in FeCl₃

Quantities of 1-15 gr. of Al(99.9% wire, 99% granules, beverage cans and Aluminum foil) were added to 20-80 cc water solution containing 10-40% w/w solid FelCl₃. Ratio of Al to FeCl₃ was 0.025-7.5.

The first H₂ bubble emerged almost immediately after the introduction of the first Al gr. and reaction duration ranged from several minutes to about two hours.

Average reaction flow rates were 1.0 ml/gr/min at R.T. to 334 ml/gr/min at R.T. both without stirring or addition of a catalyst

Initial reaction temperatures were 17-80° C., while its exothermic nature increased solution temperature to about 70° C. even if the process was carried at R.T.

In accordance with reaction progress, pH values increased from −1 to 5.

It is possible to partition the aluminum water reaction into three stages based on the reaction dynamics: induction stage, production stage where most of the hydrogen is obtained and the decay stage. It is possible to perform different reaction stages in different chemical environments.

Specifically, the induction stage (the hydration of the aluminum oxide layer) can proceed in AlCl₃/FeCl₃ medium that can be replaced to H₂O media once the production stage is reached. This procedure can prove to be beneficial to the by-product catalyst separation stage while maintaining high overall reaction rates.

Buchner flask (an Erlenmeyer flask with hose barb) of 100/125/250 ml was commonly used for the reaction. Gas was collected through a rubber tube connected to a water filled 1.5-liter plastic bottle placed upside down with head dipped in a water vessel. The gas emitted by the reaction enter the bottle replacing the water allowing thus the measurement of emitted gas quantity

The flask was filled with 80 ml of technical grade FeCl₃ solution (20% w/w concentration) having negative pH values and a dark red color due to the high concentration of the Fe⁺³ ions.

Aluminum foil was introduced into the solution 0.5 gr at the time. After addition of the first 0.5 gr immediate hydrogen emission is observed even without heating or stirring and a total of 430 ml of Hydrogen is emitted in about 75 seconds at rate of 11.5 ml/min/gr.

Adding additional rounds of 0.5 gr will slightly increase the emission rate due to the carbon contained in the Aluminum foil catalyzing the Al-water reaction as well as due to the exothermic nature of the reaction increasing the temperature from one round to the next.

Even-though the experiments were carried out without heating the flask is heated and the solution reach temperature of 60-70° C. due to exothermic nature of both Al-water as well as reduction of the Fe⁺³ ions to Fe⁺² reaction taking place simultaneously in the solution.

Ideally each 0.5 gr of Al should yield 680 ml of Hydrogen. Yet, in practice the yield is lower as some of the Al interacts with the Fe⁺³ ions. On the other hand, the Fe₍ₛ₎ produced in the reduction interaction interacts with the H⁺ protons of the solution yielding H₂ molecules but in a slower reaction than the one of Al-water. Overall, leaving the Fe₍ₛ₎ in the solution will reduce the efficiency loses.

The overall amount of Al that can be added to the solution could reach 10 gr but at the last rounds a gelatinlike precipitate starts precipitating reducing the magnetic stirring and the Hydrogen production rate decrease substantially.

The pH of the solution will maintain values lower than 1-1.2 throughout most of the process. Toward the last 0.5 gr Al adding cycles and the formation of the gelatin-like precipitation the pH will gradually increase to 2.

It is possible to partition the aluminum water reaction into three stages based on the reaction dynamics: induction stage, production stage where most of the hydrogen is obtained and the decay stage It is possible to perform different reaction stages in different chemical environments.

Specifically, the induction stage (the hydration of the aluminum oxide layer) can proceed in AlCl₃/FeCl₃ medium that can be replaced to H₂O media once the production stage is reached. This procedure can prove to be beneficial to the by-product catalyst separation stage while maintaining high overall reaction rates.

The present invention further provides a process for obtaining alumina (Al₂O₃) from Al(OH)₃. Said alumina is obtained from Al(OH)₃ produced in the above-described process for obtaining hydrogen gas from the reaction of aluminum with aluminum chloride.

The reducing agent for the described process, namely aluminum, can be obtained from secondary materials. In the present context secondary materials are aluminum containing products e.g., packaging materials, cans, foils, food wrappers and containers and the like. The present invention further provides methods for processing secondary materials in order to convert said secondary materials to reagents for the present process.

Surprisingly, it has been found that certain secondary materials provide improved results in comparison to other sources of aluminum. Improved results are in terms of conversion, yield and product purity. For example, 0.5 gr of pure Aluminum granules and wire gave only poor hydrogen ejection rates (1 ml/min for the wire and 2.9 ml/min for the granules) as compared to 70 ml/min for the same amount of aluminum foil and 38 ml/min for beverage cans.

The use of secondary materials is beneficial in terms of price, availability and environmental impact. The secondary materials are recycled and thus do not burden the environment with waste and landfills.

1.-78. (canceled)

79. A process for continuous production of hydrogen gas, the process comprising combining at least one metal and a Lewis acid in an aqueous medium at a temperature between 4 and 85° C. and a pH between −2 (negative 2) and 3 thereby causing hydrogen gas evolution, whereby an acidity-neutralizing material is formed, the acidity-neutralizing material is removed, thereby maintaining continuous production of hydrogen gas.

80. The process according to claim 79, wherein the at least one metal is selected amongst transition metals, alkali metals and earth alkali metals, an alloy or a metal oxide thereof.

81. The process according to claim 80, wherein the metal is selected from iron (Fe), cobalt (Co), manganese (Mn), aluminum (Al), gallium (Ga), indium (In), magnesium (Mg) and zinc (Zn).

82. The process according to claim 80, wherein the at least one metal is a technical grade metal or metal oxide or metal alloy provided in a shredded or cut form or as metal scrap, swarf, turnings, or chips.

83. The process according to claim 79, wherein the Lewis acid is selected from metal chlorides, metal bromides, metal fluorides, metal nitrates, metal sulfates and non-metallic Lewis acids.

84. The process according to claim 83, wherein the Lewis acid is selected from ferric chloride (FeCl₃), ferric bromide (FeBr₃), aluminum chloride (AlCl₃), aluminum fluoride (AlF₃), carbon dioxide (CO₂), sulfur dioxide (SO₂), nitrogen dioxide (NO₂), boron trifluoride (BF₃), magnesium chloride (MgCl₂), zinc chloride (ZnCl₂), FeNO₃, and FeSO₄.

85. The process according to claim 79, wherein the metal:Lewis acid ratio is between 1:10 and 10:1 or between 1:1000 and 1000:1.

86. The process according to claim 79, wherein the metal is iron and the Lewis acid is AlCl₃, the metal:Lewis acid ratio is between 0.03 and 5.

87. The process according to claim 79, wherein the metal is aluminum, the metal:Lewis acid ratio is between 0.025 and 7.5.

88. The process according to claim 79, wherein the aqueous medium is or comprises tap water, reclaimed water, industrial grade water, sewage water, deionized (DI) water, brine, upper ground salt-water, swamp water, contaminated waters or gray waters and sea water.

89. A process for a continuous production of hydrogen, the process comprising treating a combination of a metal-containing material being a technical grade metal and a technical grade Lewis acid in an aqueous medium selected from tap water, reclaimed water, industrial grade water, sewage water, deionized (DI) water, brine, upper ground salt-water, swamp water, contaminated waters or gray waters and sea water, at a temperature between 4 and 85° C. under conditions permitting evolution of hydrogen gas; and
optionally removing acidity-neutralizing materials formed, to maintain hydrogen gas production.

90. The process according to claim 89, wherein the aqueous medium is a water having a pH below 4.

91. The process according to claim 89, wherein the temperature is between 4° C. and room temperature.

92. The process according to claim 89, wherein the pH is between −2 and 3, or between −2 and 1.5, at room temperature.

93. The process according to claim 89, wherein the acidity neutralizing material is a basic species or a hydroxide salt or a weak base metal oxide derived from a reaction between the metal and the Lewis acid, in the aqueous medium, or from a contaminant present with technical grade materials.

94. The process according to claim 93, wherein the metal is aluminum and/or the Lewis acid is aluminum chloride, the acidity-neutralizing material is an aluminum hydroxide species.

95. The process according to claim 94, wherein the aluminum hydroxide species is one or more of Al₅Cl₃(OH)₁₂*7.5(H₂O), Al₅Cl₃(OH)₁₂*4(H₂O), Al₁₀C₁₄(OH)₂₆*X(H₂O), Al₁₀Cl₃(OH)₂₇*13(H₂O), Al₁₃Cl₁₅(OH)₂₄*37(H₂O), Na₂Al₂O₄, alpha Al₂O₃, theta Al₂O₃, gamma Al₂O₃, amorphous alpha Al₂O₃, AlOOH*XH₂O, AlCl₂OH*XH₂O, AlCl(OH)₂*XH₂O, wherein x defines a number of water molecules in a hydrate, optionally being 1, 2, 3, 4, 5, or 6 or any fraction thereof.

96. The process according to claim 89, comprising
treating a combination of a metal-containing material being a technical grade metal and a technical grade Lewis acid in an aqueous medium at a temperature between 4 and 85° C. and at a pH between −2 (negative 2) and 3, to cause evolution or production of hydrogen gas; wherein the aqueous medium is selected from tap water, reclaimed water, industrial grade water, sewage water, deionized (DI) water, brine, upper ground salt-water, swamp water, contaminated waters or gray waters and sea water; and
removing acidity-neutralizing materials that are formed, by decantation, filtration, or by adsorbing on an adsorbent material, to thereby maintain hydrogen gas production.

97. The process according to claim 79, comprising
treating a combination of an aluminum-containing material being a technical grade aluminum and a technical grade aluminum chloride in an aqueous medium at a temperature between 4 and 85° C. and at a pH between −2 (negative 2) and 3, to cause evolution or production of hydrogen gas; wherein the aqueous medium is selected from tap water, reclaimed water, industrial grade water, sewage water, deionized (DI) water, brine, upper ground salt-water, swamp water, contaminated waters or gray waters and sea water; and
removing by decantation, filtration, or by adsorbing on an adsorbent material any one of more materials selected from Al₅Cl₃(OH)₁₂*7.5(H₂O), Al₅Cl₃(OH)₁₂*4(H₂O), Al₁₀Cl₄(OH)₂₆*X(H₂O), Al₁₀C₁₃(OH)₂₇*13(H₂O), Al₁₃Cl₁₅(OH)₂₄*37(H₂O), Na₂Al₂O₄, alpha Al₂O₃, theta Al₂O₃, gamma Al₂O₃, amorphous alpha Al₂O₃, AlOOH*XH₂O, AlCl₂OH*XH₂O, AlCl(OH)₂*XH₂O, wherein x defines a number of water molecules in a hydrate, optionally being 1, 2, 3, 4, 5, or 6 or any fraction thereof, to thereby maintain hydrogen gas production.

98. The process according to claim 97, wherein the ratio (w/w) between the aluminum and the aluminum chloride is between 1:10 to 1:1000 and/or 10:1 to 1000:1.
